(19) United States
(12) Patent Application Publication
(10) Pub. No.: US 2011/0099588 A1
(43) Pub. Date: Apr. 28, 2011

(54) SYSTEMS AND METHODS FOR IN-FLIGHT RESOURCE MANAGEMENT

(75) Inventor: Jason Ashton, (US)

(73) Assignee: CommonWealth Intellectual Property Holdings, Inc., Santa Cruz, CA (US)

(21) Appl. No.: 12/604,769

(22) Filed: Oct. 23, 2009

(51) Int. Cl. H04N 7/18; G06F 3/041

(52) U.S. Cl. 725/75; 345/173

(57) ABSTRACT

A method for allocating resources to passengers of passenger carrier vehicles is provided where one or more computer systems aboard a passenger carrier vehicle receive a request from a passenger to make use of a resource available to passengers of the passenger carrier vehicle. The request can be made via an entertainment system aboard a passenger carrier vehicle having a graphical user interface displayed at the passenger's assigned passenger location. The one or more computer systems aboard the passenger carrier vehicle can cause a first visual indicator to be displayed to the passenger via the graphical user interface displayed at the user's assigned passenger location acknowledging the request and instructing the passenger to remain in the passenger's assigned passenger location. The one or more computer systems aboard the passenger carrier vehicle can determine placement of the passenger into a queue associate with the resource. The one or more computer systems aboard the passenger carrier vehicle then can determine availability of the resource for the passenger. The one or more computer systems aboard the passenger carrier vehicle can cause a second visual indicator to be displayed to the passenger via the graphical user interface displayed at the user's assigned passenger location indicating that the passenger may leave the passenger's assigned passenger location and make use of the resource.

### BACKGROUND OF THE INVENTION

The present invention relates to a resource management system for predicting availability of a resource aboard a passenger carrier vehicle and assigning resource use.

As is typical, use of a resource aboard a passenger carrier vehicle, such as trains, planes, and motor coaches is first-come first-served. Often, as occasion demands, this leads to individuals queuing-up to wait their turn to make use of washrooms, drinking fountains, vending machines, and other amenities offered while commuting or traveling. However, such lines may become long and frustrating to those waiting in line and discouraging to those that need to make use of the resource but have not yet entered the queue. Additionally, this may be disruptive to other passengers as the line can potentially intrude on their already limited assigned areas. Moreover, individuals being allowed to congregate in sensitive areas of a vehicle may pose certain security risks.

Accordingly, what is desired is to solve problems relating to resource management using existing audio/video equipment of a passenger carrier vehicle, some of which may be discussed herein. Additionally, what is desired is to reduce drawbacks related to resource management aboard a passenger carrier vehicle, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be present some innovations, embodiments, and/or examples found within this disclosure in a simplified form as a prelude to a more detailed description presented later.

A method for allocating resources to passengers of passenger carrier vehicles is provided where one or more computer systems aboard a passenger carrier vehicle receive a request from a passenger to make use of a resource available to passengers of the passenger carrier vehicle. The request can be made via an entertainment system aboard a passenger carrier vehicle having a graphical user interface displayed at the passenger's assigned passenger location. The one or more computer systems aboard the passenger carrier vehicle can cause a first visual indicator to be displayed to the passenger via the graphical user interface displayed at the user's assigned passenger location acknowledging the request and instructing the passenger to remain in the passenger's assigned passenger location. The one or more computer systems aboard the passenger carrier vehicle can determine placement of the passenger into a queue associate with the resource. The one or more computer systems aboard the passenger carrier vehicle then can determine availability of the resource for the passenger. The one or more computer systems aboard the passenger carrier vehicle can cause a second visual indicator to be displayed to the passenger via the graphical user interface displayed at the user's assigned passenger location indicating that the passenger may leave the passenger's assigned passenger location and make use of the resource.

A further understanding of the nature of and equivalents to the subject matter of this disclosure (as wells as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is an illustration of an interface to an entertainment system aboard a passenger carrier vehicle that may be used with one or more embodiments.

FIG. 2 is a simplified flowchart of a method for resource management in one embodiment according to the present invention.

FIG. 3 is an illustration of a graphical user interface in one embodiment that may be used to allow a passenger to request use of a resource.

FIGS. 4A and 4B are illustrations of the graphical user interface of FIG. 3 in various embodiments based on a passengers request to make use of a resource.

FIG. 5 is a block diagram of a computer system or information processing device that may be used to implement or practice various embodiments of an invention whose teachings may be presented herein.

### DETAILED DESCRIPTION OF THE INVENTION

The time spent commuting or traveling passes more quickly for passengers when they are engaged. Increasingly, vehicles, airplanes and motor coaches have become equipped with audio and video equipment intended to keep passengers engaged while traveling or commuting. Passengers can now interact with the Internet, work on a computer, play video games or watch video entertainment. Manufacturers have equipped these passenger vehicles, for several years, with video entertainment systems. Large vehicles, such as vans or SUV's often have video monitors hanging from the roof, mounted in the dashboard or center armrest or mounted in the back a the headrest or seat. Video monitors for displaying visual images have been commonplace aboard commercial aircraft for quite some time. These monitors may be adapted to be mounted in a seat back of an vehicle or aircraft seat.

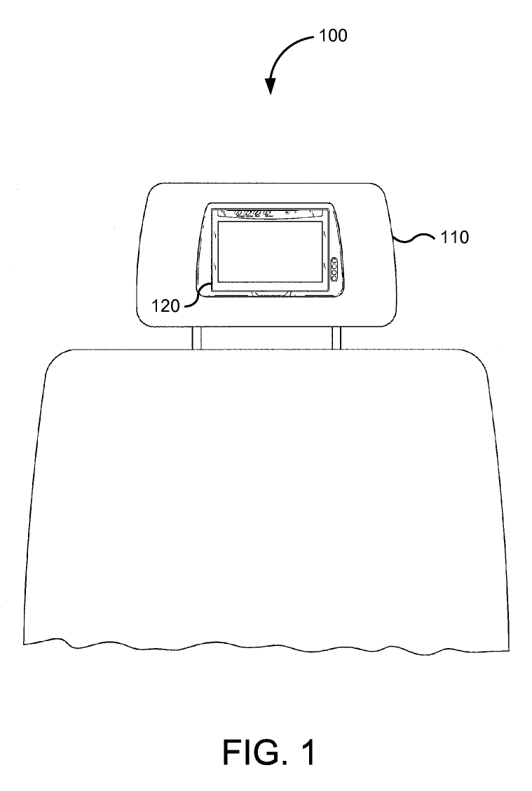

FIG. 1 is an illustration of interface 300 to an entertainment system aboard a passenger carrier vehicle that may be used with one or more embodiments. In this example, interface 300 includes mount 110 having a video monitor or display 120. Interface 300 is typically found in a passenger's assigned location, such as in the headrest of the seat in front of the passengers assigned or chosen seat. Interface 300 may further be found in a first or business class area for the passenger, a sleeping or traveling compartment, or the like. Interface 300 may also be provided by a user's mobile device in communication with the entertainment system or resource management system of the passenger carrier vehicle.

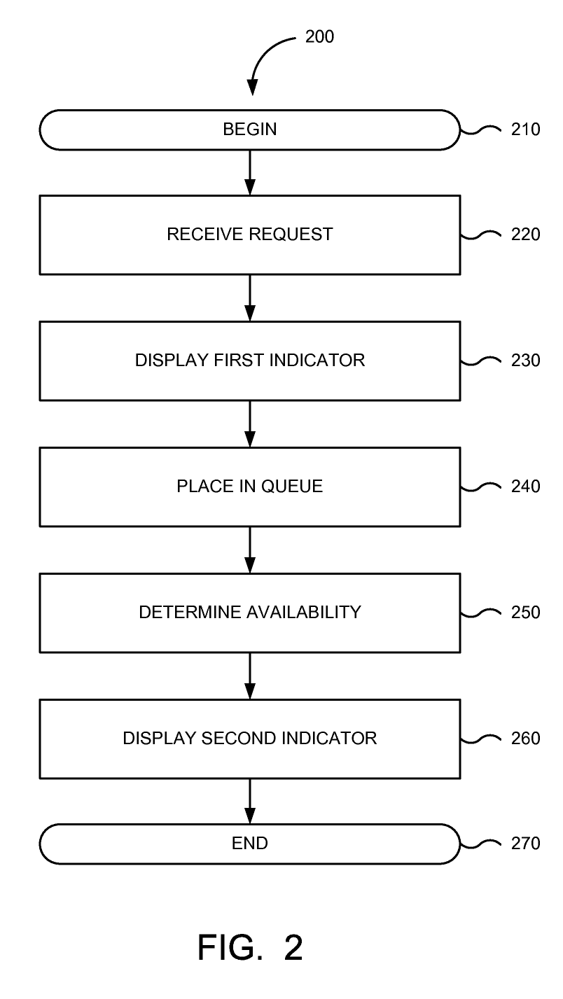

FIG. 2 is a simplified flowchart of a method for resource management in one embodiment according to the present invention. The processing of method 200 depicted in FIG. 2 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 200 depicted in FIG. 2 begins in step 210.

In step 220, a request is received. For example, a passenger of a passenger carrier vehicle may issue a request for or to make use of a resource available aboard the passenger carrier vehicle. The resource may be a washroom, restroom, kiosk, power facility, vending machine, food distribution service, library, or the like. The request may be made at the passengers assigned or otherwise chosen passenger location, such as the passenger's seat, cabin, compartment, or the like. In various embodiments, the request can be made via an entertainment system offered by the passenger carrier vehicle. The passenger may interact with one or more user interfaces of the entertainment system (e.g., a graphical user interface) to determine what resources are provided and make one or more selections of the provided resources.

In step 230, a first indicated is displayed to the passenger. For example, based on selecting an icon representing a resource, a visual indicator may be displaying to the passenger acknowledging the request of the passenger to make use of the resource. The visual indicator may further provide instructions to the passenger, such as directions to the resource, whether the resource is currently available or unavailable, expected wait time, expected waiting area, or the like. The first indicator may be provided through audio or visual means.

In step 240, the passenger is placed in a queue. The passenger may be placed in a queue for the resource using one or more queuing techniques, such as first-in first-out (FIFO) or the like. The passenger or the passenger's assigned location may be used to determine the passengers placement or advancement in the queue. Other information or criteria may be used.

In step 250, availability of the resource is determined. Availability may be determined for an individual passenger or for a group of passengers. A future or expected availability may also be determined.

In step 260, a second indicator is displayed to the passenger. For example, based on the determined availability of the resource, a visual indicator may be displaying to the passenger indicating that the passenger may now make use of the resource. The visual indicator may further provide instructions to the passenger, such as directions to the resource, whether the resource is currently available or unavailable, expected wait time, expected waiting area, or the like. The second indicator may be provided through audio or visual means. FIG. 2 ends in step 270.

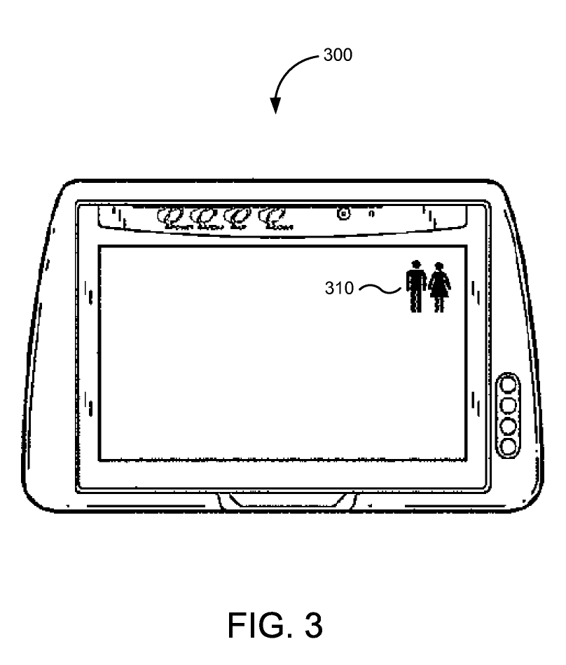

FIG. 3 is an illustration of graphical user interface 300 in one embodiment that may be used to allow a passenger to request use of a resource. In this example, visual indicator 310 for a restroom is displayed on a screen used by a passenger as an entertainment center or internet kiosk. The passenger may touch, highlight, or otherwise select visual indicator 310 to request to make use of the restroom.

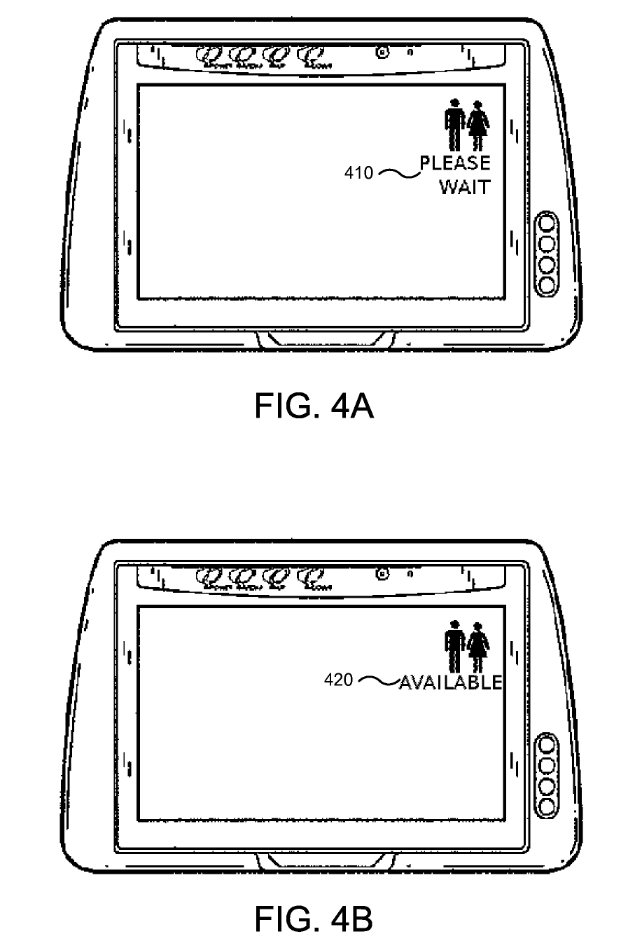

FIGS. 4A and 4B are illustrations of graphical user interface 300 of FIG. 3 in various embodiments based on a passengers request to make use of a resource. For example, in FIG. 3A, information 410 is provided indicating that the passenger requesting to make use of the restroom should currently wait in the passenger's designated passenger location until the restroom is available. In another example, information 420 is provided indicating that that the passenger requesting to make use of the restroom may now make use of the restroom.

In various embodiments, information 410 and 420 may be provide visually or audibly. Information 410 and 420 may include colors, animations, or other effects to indicate a particular meaning to the passenger.

Accordingly, a resource management system is provided that can make use of an existing entertainment system aboard a passenger carrier vehicle, such as an airplane or motor coach. The resource management system may place passengers in queues for resources such that passengers do not congregate in areas that need to be secured or bother other passengers as they wait to make use of the resource.

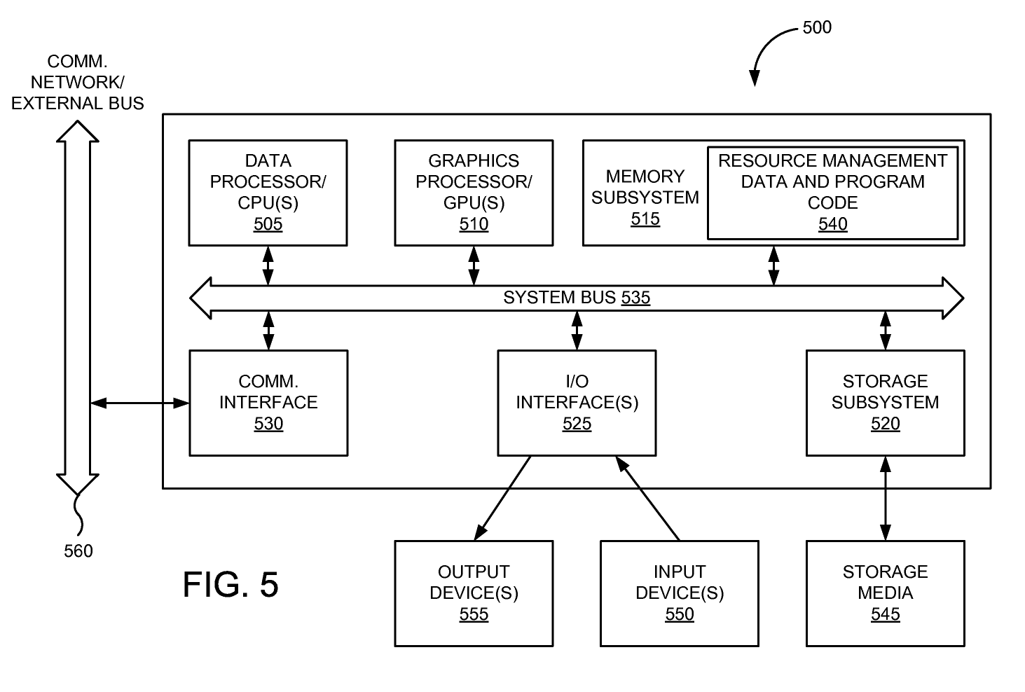

FIG. 5 is a block diagram of computer system 500 that may be used to implement or practice various embodiments of an invention whose teachings may be presented herein. FIG. 5 is merely illustrative of a computing device, general-purpose computer system programmed according to one or more disclosed techniques, or specific information processing device for an embodiment incorporating an invention whose teachings may be presented herein and does not limit the scope of the invention as recited in the claims. One of ordinary skill in the art would recognize other variations, modifications, and alternatives.

Computer system 500 can include hardware and/or software elements configured for performing logic operations and calculations, input/output operations, machine communications, or the like. Computer system 500 may include familiar computer components, such as one or more one or more data processors or central processing units (CPUs) 505, one or more graphics processors or graphical processing units (GPUs) 510, memory subsystem 515, storage subsystem 520, one or more input/output (I/O) interfaces 525, communications interface 530, or the like. Computer system 500 can include system bus 535 interconnecting the above components and providing functionality, such connectivity and inter-device communication. Computer system 500 may be embodied as a computing device, such as a personal computer (PC), a workstation, a mini-computer, a mainframe, a cluster or farm of computing devices, a laptop, a notebook, a netbook, a PDA, a smartphone, a consumer electronic device, a gaming console, or the like.

The one or more data processors or central processing units (CPUs) 505 can include hardware and/or software elements configured for executing logic or program code or for providing application-specific functionality. Some examples of CPU(s) 505 can include one or more microprocessors (e.g., single core and multi-core) or micro-controllers, such as PENTIUM, ITANIUM, or CORE 2 processors from Intel of Santa Clara, Calif. and ATHLON, ATHLON XP, and OPTERON processors from Advanced Micro Devices of Sunnyvale, Calif. CPU(s) 505 may also include one or more field-gate programmable arrays (FPGAs), application-specific integrated circuits (ASICs), or other microcontrollers. The one or more data processors or central processing units (CPUs) 505 may include any number of registers, logic units, arithmetic units, caches, memory interfaces, or the like. The one or more data processors or central processing units (CPUs) 505 may further be integrated, irremovably or moveably, into one or more motherboards or daughter boards.

The one or more graphics processor or graphical processing units (GPUs) 510 can include hardware and/or software elements configured for executing logic or program code associated with graphics or for providing graphics-specific functionality. GPUs 510 may include any conventional graphics processing unit, such as those provided by conventional video cards. Some examples of GPUs are commercially available from NVIDIA, ATI, and other vendors. In various embodiments, GPUs 510 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 510 may include any number of registers, logic units, arithmetic units, caches, memory interfaces, or the like. The one or more data processors or central processing units (CPUs) 505 may further be integrated, irremovably or moveably, into one or more motherboards or daughter boards that include dedicated video memories, frame buffers, or the like.

Memory subsystem 515 can include hardware and/or software elements configured for storing information. Memory subsystem 515 may store information using machine-readable articles, information storage devices, or computer-readable storage media. Some examples of these articles used by memory subsystem 570 can include random access memories (RAM), read-only-memories (ROMS), volatile memories, non-volatile memories, and other semiconductor memories. In various embodiments, memory subsystem 515 can include resource management data and program code 540.

Storage subsystem 520 can include hardware and/or software elements configured for storing information. Storage subsystem 520 may store information using machine-readable articles, information storage devices, or computer-readable storage media. Storage subsystem 520 may store information using storage media 545. Some examples of storage media 545 used by storage subsystem 520 can include floppy disks, hard disks, optical storage media such as CD-ROMS, DVDs and bar codes, removable storage devices, networked storage devices, or the like. In some embodiments, all or part of resource management data and program code 540 may be stored using storage subsystem 520.

In various embodiments, computer system 500 may include one or more hypervisors or operating systems, such as WINDOWS, WINDOWS NT, WINDOWS XP, VISTA, or the like from Microsoft or Redmond, Wash., SOLARIS from Sun Microsystems, LINUX, UNIX, and UNIX-based operating system. Computer system 500 may also include one or more applications configured to executed, perform, or otherwise implement techniques disclosed herein. These applications may be embodied as resource management data and program code 540. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 515 and/or storage subsystem 520.

The one or more input/output (I/O) interfaces 525 can include hardware and/or software elements configured for performing I/O operations. One or more input devices 550 and/or one or more output devices 555 may be communicatively coupled to the one or more I/O interfaces 525.

The one or more input devices 550 can include hardware and/or software elements configured for receiving information from one or more sources for computer system 500. Some examples of the one or more input devices 550 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 550 may allow a user of computer system 500 to interact with one or more non-graphical or graphical user interfaces to enter a comment, select objects, icons, text, user interface widgets, or other user interface elements that appear on a monitor/display device via a command, a click of a button, or the like.

The one or more output devices 555 can include hardware and/or software elements configured for outputting information to one or more destinations for computer system 500. Some examples of the one or more output devices 555 can include a printer, a fax, a feedback device for a mouse or joystick, external storage systems, a monitor or other display device, a communications interface appropriately configured as a transceiver, or the like. The one or more output devices 555 may allow a user of computer system 500 to view objects, icons, text, user interface widgets, or other user interface elements.

A display device or monitor may be used with computer system 500 and can include hardware and/or software elements configured for displaying information. Some examples include familiar display devices, such as a television monitor, a cathode ray tube (CRT), a liquid crystal display (LCD), or the like.

Communications interface 530 can include hardware and/or software elements configured for performing communications operations, including sending and receiving data. Some examples of communications interface 530 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 530 may be coupled to communications network/external bus 580, such as a computer network, to a FireWire bus, a USB hub, or the like. In other embodiments, communications interface 530 may be physically integrated as hardware on a motherboard or daughter board of computer system 500, may be implemented as a software program, or the like, or may be implemented as a combination thereof.

In various embodiments, computer system 500 may include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 500.

As suggested, FIG. 5 is merely representative of a general-purpose computer system appropriately configured or specific data processing device capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within this disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may techniques described above as implemented upon a chip or an auxiliary processing board.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A computer-implemented method for allocating resources to passengers of passenger carrier vehicles, the method comprising:
receiving, at one or more computer systems aboard a passenger carrier vehicle, a request from a passenger to make use of a resource available to passengers of the passenger carrier vehicle, the request made via an entertainment system aboard a passenger carrier vehicle having a graphical user interface displayed at the passenger's assigned passenger location;
causing, with the one or more computer systems aboard the passenger carrier vehicle, a first visual indicator to be displayed to the passenger via the graphical user interface displayed at the user's assigned passenger location acknowledging the request and instructing the passenger to remain in the passenger's assigned passenger location;
determining, with the one or more computer systems aboard the passenger carrier vehicle, placement of the passenger into a queue associate with the resource;
determining, with the one or more computer systems aboard the passenger carrier vehicle, availability of the resource for the passenger; and
causing, with the one or more computer systems aboard the passenger carrier vehicle, a second visual indicator to be displayed to the passenger via the graphical user interface displayed at the user's assigned passenger location indicating that the passenger may leave the passenger's assigned passenger location and make use of the resource.

2. The method of claim 1 wherein the graphical user interface includes a touch screen.

3. The method of claim 1 wherein the resource comprises a bathroom.

4. The method of claim 1 wherein the resource comprises food service.

5. The method of claim 1 wherein determining, with the one or more computer systems aboard the passenger carrier vehicle, placement of the passenger into a queue associate with the resource comprises determining placement based on a security policy.

6. The method of claim 1 wherein determining, with the one or more computer systems aboard the passenger carrier vehicle, placement of the passenger into a queue associate with the resource comprises determining placement based on distance between the passenger's assigned passenger location and the resource.

7. The method of claim 1 wherein determining, with the one or more computer systems aboard the passenger carrier vehicle, placement of the passenger into a queue associate with the resource comprises determining placement based on classification of the passenger's assigned passenger location.

8. The method of claim 1 wherein determining, with the one or more computer systems aboard the passenger carrier vehicle, availability of the resource for the passenger comprises determining that fewer than a predetermined number of passengers are using the resource.

9. A computer-readable storage medium storing a computer program product executable by one or more computer systems for implementing the method of claim 1.
